(19) United States
(12) Patent Application Publication
(10) Pub. No.: US 2025/0303455 A1
(43) Pub. Date: Oct. 2, 2025

(54) GARBAGE DISPOSAL DEVICE AND CONTROL METHOD THEREOF, AND COMPOSTING SYSTEM

(71) Applicant: Vego Innovations, Inc., Tomball, TX (US)

(72) Inventors: Guangyuan XIONG, Tomball, TX (US); Li XIANG, Shenzhen (CN); Yaxiong WEN, Shenzhen (CN)

(73) Assignee: Vego Innovations, Inc., Tomball, TX (US)

(21) Appl. No.: 18/791,472

(22) Filed: Aug. 1, 2024

(30) Foreign Application Priority Data
Mar. 28, 2024 (CN) 202410374524.0

(51) Int. Cl. B09B 3/60; B08B 15/00; B09B 3/38; B09B 3/40; B09B 101/70

(52) U.S. Cl. CPC B09B 3/60; B08B 15/00; B09B 3/38; B09B 3/40; B09B 2101/70

(57) ABSTRACT

A garbage disposal device includes an external enclosure, an internal barrel, a cover, and an air freshening unit. The external enclosure is formed with an interior chamber and an access opening in communication with the interior chamber. The internal barrel is formed with a reaction chamber and an introduction opening in communication with the reaction chamber. The reaction chamber receives kitchen waste therein. The internal barrel is placed in the interior chamber. The cover is arranged in the access opening. A first gap is present between the cover and the access opening. The air freshening unit includes a blower, an air inlet passage, and an air outlet passage. The blower draws air out of the reaction chamber through the air inlet passage to allow external air to flow through the first gap into the reaction chamber for reaction of the kitchen waste inside the reaction chamber.

### TECHNICAL FIELD

The application relates to the field of garbage processing, and more particularly to a garbage disposal device and a control method thereof, and a composting system.

### BACKGROUND OF THE ART

To effectively utilize kitchen waste, more and more users intend to make a second use of the kitchen waste. And as such, a garbage disposal device is available from the market. The user may place the kitchen waste generated in daily living in the garbage disposal device, and the garbage disposal device converts the kitchen waste into an organic fertilizer to be absorbed by green plants to fulfill secondary use.

The existing garbage disposal device needs to spend an extended period of time to process kitchen waste, for the purposes of allowing microorganisms to act on the kitchen waste. During the course of reaction, kitchen waste may get accumulated and this easily results in insufficient reaction of the kitchen waste.

### SUMMARY OF THE INVENTION

An objective of the application is to provide a garbage disposal device and a control method thereof, and a composting system, aiming to resolve the technical issue of insufficiency of reaction of kitchen waste.

In one aspect, the present invention provides a garbage disposal device which comprises:
an external enclosure, the external enclosure being formed with an interior chamber and an access opening in communication with the interior chamber;
an internal barrel, the internal barrel being formed with a reaction chamber and an introduction opening in communication with the reaction chamber, the reaction chamber being configured to accommodate kitchen waste therein, the internal barrel being disposed in the interior chamber, the introduction opening facing the access opening;
a cover, the cover being arranged in the access opening, a first gap being present between the cover and the access opening; and
an air freshening unit, the air freshening unit comprising a blower, an air inlet passage, and an air outlet passage, an air ingress portion of the blower being in communication with the air inlet passage, an air egress portion of the blower being in communication with the air outlet passage, the air inlet passage being in communication with the reaction chamber. The blower is operable to draw air from the reaction chamber through the air inlet passage to allow external air to flow through the first gap into the reaction chamber for reaction of the kitchen waste inside the reaction chamber.

In some embodiments, the external enclosure comprises an enclosure wall which is configured to form the air inlet passage and the air outlet passage, and the blower is arranged in the external enclosure.

In some embodiments, a mounting compartment is arranged in a bottom portion of the external enclosure, and the blower is mounted in the mounting compartment, the air inlet passage being located in an external sidewall of the interior chamber, the air outlet passage being adjacent to the air inlet passage, the air inlet passage and the air outlet passage being both extending from a top portion of the external enclosure to the bottom portion, an air intake opening being formed in a top portion of the air inlet passage, the air intake opening being in communication with the reaction chamber, a bottom portion of the air inlet passage being in communication with a top portion of the mounting compartment, a bottom portion of the air outlet passage being in communication with a sideway portion of the mounting compartment, an air exhaust opening being arranged in a top portion of the air outlet passage, the air exhaust opening being arranged at an external wall of the external enclosure.

In some embodiments, the air exhaust opening is located in a sidewall between the top portion and the bottom portion of the external enclosure.

In some embodiments, the external enclosure comprises a first casing and a second casing, the air exhaust opening being arranged in an external wall of the second casing, the first casing being formed with an air exhaust compartment having a sidewall having an opening, an air intake compartment being formed in a compartment bottom of the air exhaust compartment and facing the opening of the sidewall, the second casing being detachably connected to the first casing, the external wall of the second casing covering and closing the opening of the air exhaust compartment, an internal wall of the second casing covering and closing an opening of the air intake compartment, the air exhaust compartment and the external wall and the internal wall of the second casing cooperatively forming at least a portion of the air outlet passage, the internal wall of the second casing and the air intake compartment cooperatively forming at least a portion of the air inlet passage.

In some embodiments, a cross-sectional area of the air outlet passage perpendicular to a flowing direction is greater than a cross-sectional area of the air inlet passage perpendicular to the flowing direction.

In some embodiments, the air freshening unit further comprises a filter assembly arranged in the air outlet passage.

In some embodiments, the first gap is located between a circumference of the cover and the access opening.

In some embodiments, the garbage disposal device further comprises a stirring mechanism which comprises a stirring blade support, a stirring axle, and a stirring electric motor, the stirring electric motor being arranged in the external enclosure, the stirring electric motor being connected to the stirring axle, the stirring axle partly projecting out of a bottom portion of the interior chamber; the bottom portion of the internal barrel being provided with a connection portion, the stirring blade support being located in a bottom portion of the reaction chamber and rotatably connected to the connection portion, the stirring axle extending through the connection portion and detachably connected to the stirring blade support.

In some embodiments, the garbage disposal device further comprising a weighing assembly which is arranged in a bottom portion of the interior chamber to weigh the kitchen waste accommodated in the internal barrel.

In some embodiments, the garbage disposal device further comprising a heating assembly which comprises a heat source and a heating filament being electrically connected with the heat source for heating the internal barrel; the heat source being arranged in the external enclosure; the heating filament being arranged in a bottom portion of the internal barrel or a bottom portion of the interior chamber.

In a second aspect, the present invention provides a control method applicable to the garbage disposal device described above. The method comprises:
placing the kitchen waste in the reaction chamber, and then controlling the blower to operate in an intermittent manner to successively draw after-reaction air from an interior of the reaction chamber to allow external air to flow through the first gap into the reaction chamber for full reaction of the kitchen waste.

In a third aspect, the present invention provides a composting system comprising a vermicompost bucket and the garbage disposal device described above.

The vermicompost bucket is configured to receive reaction-completed kitchen waste from the garbage disposal device to further process the reaction-completed kitchen waste.

The application provides a garbage disposal device, in which kitchen waste can be disposed through an introduction opening into a reaction chamber of an internal barrel. The internal barrel can be placed through an access opening into an interior chamber, so that the garbage disposal device may carry out processing reaction on the kitchen waste. During the course of the processing reaction, a blower draws after-reaction air out of the reaction chamber through an air inlet passage to be discharged through an air outlet passage. The reaction chamber is set in a negative pressure after the outward drawing of air, and external air may flow through a first gap into the reaction chamber to allow the reaction chamber to carry out, with the fresh air, processing reaction on kitchen waste. Further, after the processing reaction, air can be drawn out again through the air freshening unit. Such a process is cyclically repeated to allow the reaction chamber, through the fresh air, to continuously carry out processing reaction on kitchen waste. As such, it is possible to ensure full reaction of the kitchen waste, and the efficiency of kitchen waste processing by the garbage disposal device can be extremely increased.

### BRIEF DESCRIPTION OF THE DRAWINGS

To more clearly expound the technical solutions of embodiments of the application, or those of the prior art, a brief description will be given below to the drawings that are necessarily used in illustrating the embodiments or the prior art. Obviously, the drawings described below show only some of the embodiments of the application. For those having ordinary skill in the art, other drawings can be envisaged, without paying creative endeavor, from the structure illustrated in the attached drawings.

FIG. 1 is schematic structure diagram of a garbage disposal device provided in an embodiment of the application;

FIG. 2 is a schematic cross-sectional diagram of the garbage disposal device provided in the embodiment of the application;

FIG. 2A is similar to FIG. 2, showing activated carbon and filter sponge arranged above the bottom lid;

FIG. 3 is a first schematic exploded diagram of the garbage disposal device provided in the embodiment of the application;

FIG. 4 is a second schematic exploded diagram of the garbage disposal device provided in the embodiment of the application;

FIG. 5 is a schematic exploded diagram of a second casing of the garbage disposal device provided in the embodiment of the application; and

FIG. 6 illustrates a vermicompost bucket.

### LIST OF REFERENCE SIGNS

100: garbage disposal device;
10: external enclosure; 10a: interior chamber; 10b: access opening;
11: first casing; 11a: air exhaust compartment; 11b: air intake compartment; 111: locking buckle; 112: controller member; 113: elastic element; 114: fixing members;
12: second casing; 121: top shell; 1211: engagement hole; 122: bottom lid; 1221: first grating air passageway; 1222: engagement plate; 1223: engagement block;
20: internal barrel; 20a: reaction chamber; 20b: introduction opening;
30: cover; 30a: fixing notch;
40: air freshening unit; 41: air inlet passage; 411: air intake opening; 42: blower; 43: air outlet passage; 431: air exhaust opening; 44: filter chamber;
50: stirring mechanism; 51: stirring blade support; 52: stirring electric motor; 53: stirring axle;
60: weighing assembly;
70: heating assembly.

### DETAILED DESCRIPTION OF PREFERRED EMBODIMENTS

The following provides, with reference to the attached drawings of an embodiment of the application, a clear and complete description to a technical solution of the embodiment of the application. Obviously, the embodiment so described represents only some of the embodiments of the application and not all of the embodiments. Based on the embodiment of the application, those having ordinary skill in the field may envisage, without paying creative endeavor, other embodiments, which are considered falling in the scope of protection that the application pursues.

It is noted that all direction indications adopted in the embodiment of the application (such as up, down, left, right, front, rear, and the likes) are only used to explain relative positional relationships and motions of various components in a specific posture. Once the specific posture changes, the direction indications should vary accordingly.

It is also noted that when an element is referred to as being “fixed” or “arranged” on another element, it can be directly on said another element, or there may be an intermediate element existing. When an element is referred to as being “connected” to another element, it can be directly connected to said another element, or can be indirectly connected to said another element by means of an intermediate element.

Further, in the application, descriptions related to “first” and “second” are adopted for the purpose of illustration and should not be construed as indicating or suggesting relative importance or implicitly indicating the number of the technical feature so indicated. Thus, features that carry “first” and “second” explicitly or implicitly include at least one such feature. Further, the technical solutions of various embodiments may be used in combination with each other, but this is only applicable on the basis of being achievable by those having ordinary skill in the field. Such a combination of various technical solutions is deemed un-existing should there be contradiction or un-achievability for such a combination of technical solutions and is also excluded from the scope of protection that the application pursues.

A garbage disposal device may receive kitchen waste to dispose therein, so that through reaction with microorganisms, the kitchen waste can be converted into an organic fertilizer, which can be absorbed by green plants to fulfill secondary use of the kitchen waste. As the garbage disposal device is generally a household appliance, after kitchen waste is disposed into the garbage disposal device, the kitchen waste cannot communicate with the external atmosphere, and the microorganisms in the garbage disposal device may stay with the kitchen waste in an anaerobic environment for an extended period of time, and it is hard for the microorganisms to sufficiently react with the kitchen waste, resulting in insufficient reaction with the kitchen waste, and greatly extending the time interval for processing the kitchen waste. It is necessarily known that kitchen waste used in a condition of not sufficiently reacted to serve as a fertilizer for green plants may cause damage to the green plants, such as root burning and seedling burning.

For this, an embodiment of the application provides a garbage disposal device, which guarantees full reaction of kitchen waste and extremely increases the efficiency of the garbage disposal device in processing kitchen waste.

A detailed description for some embodiments of the application will be provided below, with reference to the attached drawings. Under a condition of no contradiction, the embodiments described below, and features of the embodiments, may be combined with each other.

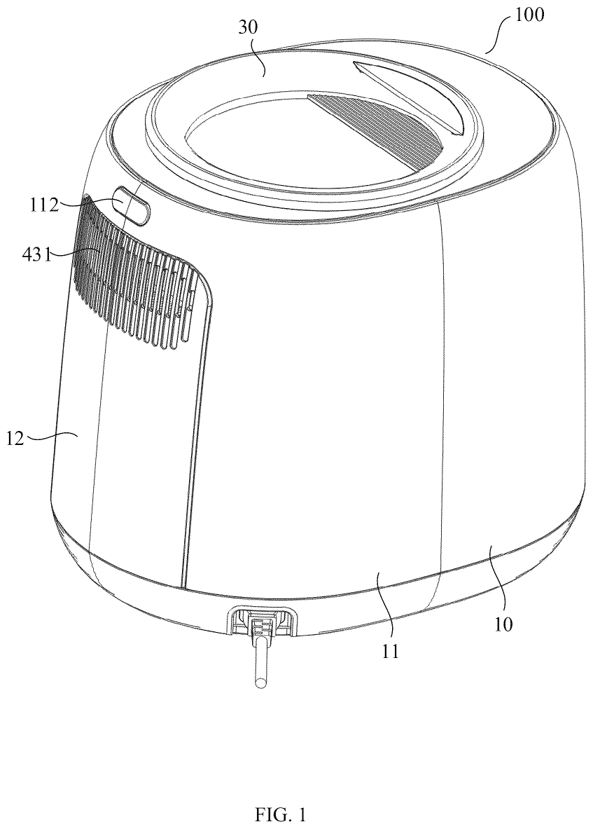

As shown in FIGS. 1-3, an embodiment of the application provides a garbage disposal device 100 which comprises an external enclosure 10, an internal barrel 20, a cover 30, and an air freshening unit 40.

The external enclosure 10 is formed with an interior chamber 10a and an access opening 10b in communication with the interior chamber 10a. The internal barrel 20 is formed with a reaction chamber 20a and an introduction opening 20b in communication with the reaction chamber 20a. The reaction chamber 20a is configured to receive kitchen waste to place therein. The internal barrel 20 is disposed in the interior chamber 10a, and the introduction opening 20b faces the access opening 10b. The cover 30 is arranged in the access opening 10b, and a first gap is present between the cover 30 and the access opening 10b. The air freshening unit 40 comprises a blower 42, an air inlet passage 41, and an air outlet passage 43. An air ingress portion of the blower 42 is in communication with the air inlet passage 41, and an air egress portion of the blower 42 is in communication with the air outlet passage 43. The air inlet passage 41 is in communication with the reaction chamber 20a. The blower 42 is operable to draw air out of the reaction chamber 20a through the air inlet passage 41, so as to allow air from the external to pass through the first gap formed between the cover 30 and the access opening 10b and flow into the reaction chamber 20a for reaction of the kitchen waste held in the reaction chamber 20a.

It is noted that after the kitchen waste is placed into the reaction chamber 20a, microorganisms contained in the reaction chamber 20a carry out reaction processing on the kitchen waste so as to convert, by means of aerobic fermentation, the kitchen waste into an organic fertilizer to be absorbed by green plants. By means of continuous inward flowing of fresh air, activity of the microorganisms is enhanced.

It is noted that the first gap is relatively small, and under the condition that internal and external atmospheric pressures are consistent, it is hard for the external air to pass through the first gap to exchange with the air in the interior of the reaction chamber 20a. By operating the blower 42 to draw out the air in the interior of the reaction chamber 20a, the atmospheric pressure in the interior of the reaction chamber 20a becomes smaller than the external atmospheric pressure, and air may flow through the first gap into the interior of the reaction chamber 20a.

It is noted that the internal barrel 20 is placeable into the interior chamber 10a, or removable from the interior chamber 10a to allow kitchen waste to dump into the reaction chamber 20a. Further, if desired, the kitchen waste can be removed from the garbage disposal device 100, or the internal barrel 20 can be removed from the interior chamber 10a to easily dump out the kitchen waste.

In the garbage disposal device 100 provided in the instant embodiment, kitchen waste can be disposed, through the introduction opening 20b, into the reaction chamber 20a of the internal barrel 20, and the internal barrel 20 can be placed, through the access opening 10b, into the interior chamber 10a, to allow the garbage disposal device 100 to carry out processing reaction on the kitchen waste. During the course of the processing reaction, the blower 42 draws, through the air inlet passage 41, reacted air from the reaction chamber 20a to be discharged through the air outlet passage 43. After air is drawn out, the reaction chamber 20a shows a negative pressure, and air from the external may flow through the first gap into the reaction chamber 20a, so that the reaction chamber 20a may use fresh air to carry out processing reaction on the kitchen waste. Further, the air after the processing reaction may once again be drawn out through the air freshening unit 40, and this can be cyclically repeated to allow continuously supply fresh air into the reaction chamber 20a for carrying out processing reaction on the kitchen waste. In this way, it is possible to guarantee full reaction of the kitchen waste and to extremely increase the efficiency of the garbage disposal device 100 for processing the kitchen waste.

The garbage disposal device 100 provided in the application is a small-sized garbage disposal device 100, which is provided for household or personal purposes. Compared to large scale garbage processing, the garbage disposal device 100 can be more conveniently used in daily living and can timely process the kitchen waste generated in daily living and also help prevent contamination caused by the kitchen waste and to fulfill secondary use.

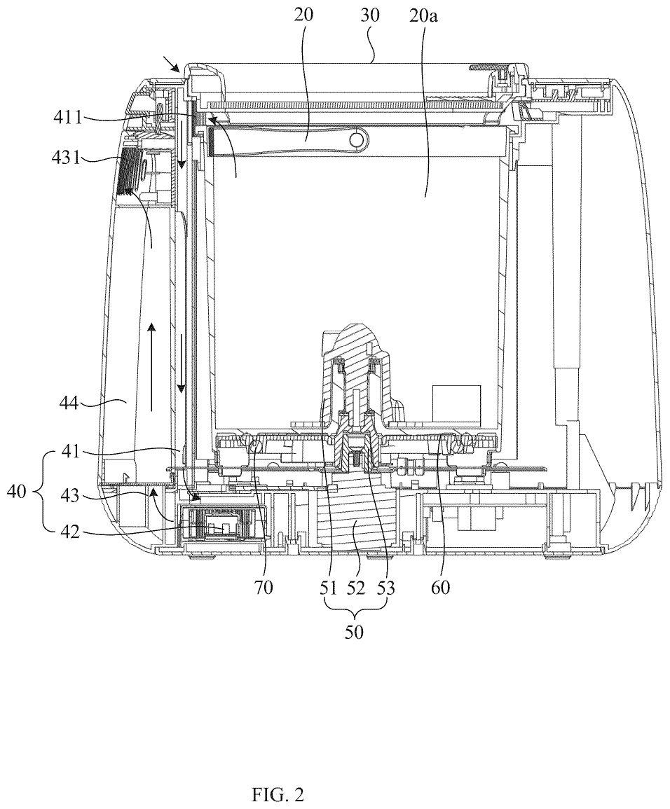

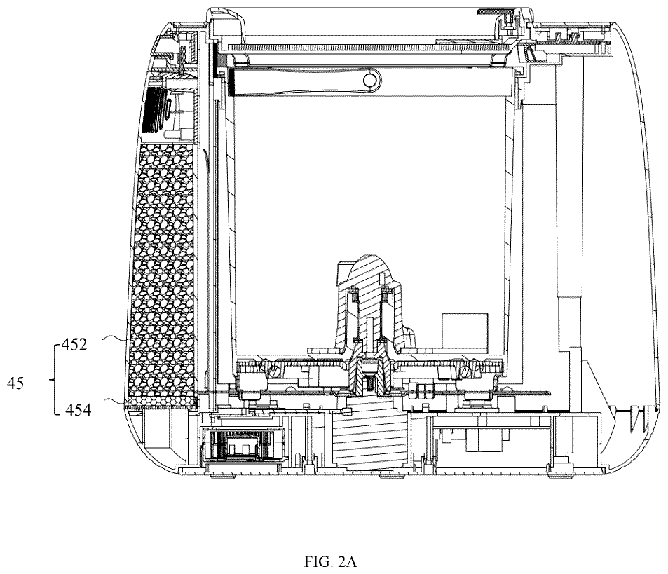

As shown in FIG. 2, in the embodiment of the application, an enclosure wall of the external enclosure 10 is formed with the air inlet passage 41 and the air outlet passage 43, and the blower 42 is arranged in the external enclosure 10. This allows the air freshening unit 40 to be integrated inside the external enclosure 10, without the need for mounting, in an additional form, the air freshening unit 40, so that the structure of the garbage disposal device 100 is made more compact and also saves space for easing household or personal uses. Certainly, in other embodiments, the air freshening unit 40 can be of a structure that is mounted additionally. For example, the air inlet passage 41 and the air outlet passage 43 are both formed of pipelines, the air inlet passage 41 extends into the reaction chamber 20a to allow the blower 42 to draw, through the pipeline, air out of the reaction chamber 20a.

As shown in FIG. 2, in the embodiment of the application, a bottom portion of the external enclosure 10 is formed with a mounting compartment, and the blower 42 is mounted in the mounting compartment. The air inlet passage 41 is formed in an external sidewall of the interior chamber 10a, and the air outlet passage 43 is arranged adjacent to the air inlet passage 41. The air inlet passage 41 and the air outlet passage 43 are both extended from a top portion of the external enclosure 10 toward the bottom portion. The air inlet passage 41 is provided, in a top portion thereof, with an air intake opening 411, and the air intake opening 411 is in communication with the reaction chamber 20a. A bottom portion of the air inlet passage 41 is in communication with a top portion of the mounting compartment. A bottom portion of the air outlet passage 43 is in communication with a sideway portion of the mounting compartment. A top portion of the air outlet passage 43 is formed with an air exhaust opening 431, and the air exhaust opening 431 is arranged at an external wall of the external enclosure 10. During operation of the blower 42, the air in the interior of the reaction chamber 20a flows through the air intake opening 411 to the top portion of the air inlet passage 41, and then flows along the air inlet passage 41, from a top side to a bottom side, toward the blower 42, and is then discharged out at one side of the blower 42 to flow along the air outlet passage 43, from a bottom side to a top side, toward the air exhaust opening 431 to be then discharged to the outside. In the embodiment, the air inlet passage 41 and the air outlet passage 43 are both arranged to extend from the top portion of the external enclosure 10 to the bottom portion, and the blower 42 is arranged in the mounting compartment located in the bottom portion of the external enclosure 10 and does not occupy the space of the interior chamber 10a in which the internal barrel 20 is placed, so as to fully use the space of the enclosure wall of the external enclosure 10 to make the garbage disposal device 100 compact. Further, extended air inlet passage 41 and air outlet passage 43 can avoid backward flow of the out-drawn air when the blower 42 is shut down, in order to ensure that external fresh air can get into the reaction chamber 20a.

It is noted that the air ingress portion of the blower 42 is in communication with a through hole between the top portion of the mounting compartment and the air inlet passage 41, and the air egress portion of the blower 42 is in communication with a through hole between the sideway portion of the mounting compartment and the air outlet passage 43, so that the blower 42 may draw in air through the air inlet passage 41 and discharge through the air outlet passage 43. Illustratively, the blower 42 can be a centrifugal blower 42, and can be mounted on a bottom portion of the mounting compartment in a manner of being horizontally laid with the air ingress portion facing upward. The blower 42 draws in air, in downward direction, through the air inlet passage 41 and then discharge the air sideways to the air outlet passage 43, so that vapor can be quickly discharged away to prevent the vapor from condensing into water in the air inlet passage 41 and the air outlet passage 43 and avoid condensed water excessively accumulating and flowing toward the bottom portion of the machine to affect normal operation of the machine.

In some embodiments, the air intake opening 411 is arranged in a sidewall of the top portion of the interior chamber 10a. After the internal barrel 20 is mounted in the interior chamber 10a, a top portion of the internal barrel 20 is below the air intake opening 411, and as such, the air intake opening 411 may be kept in communication with the reaction chamber 20a through the top portion of the interior chamber 10a in order to draw air out of the reaction chamber 20a. It is appreciated that when the blower 42 draws, through the air intake opening 411, air out of the reaction chamber 20a, the air inside the reaction chamber 20a is drawn from the bottom to the top, so that after-reaction air can be fully drawn out of the reaction chamber 20a and external air flowing through the first gap into the reaction chamber 20a can be accelerated. It is noted that due to the first gap being relatively small, it is generally hard for air to pass, and in drawing out air out of the reaction chamber 20a through the air intake opening 411, what is primarily drawn out is the air contained in the interior of the reaction chamber 20a, and a situation that the external air is directly drawn through the first gap while air inside the reaction chamber 20a is not drawn will not result.

As shown in FIGS. 1 and 2, in an embodiment of the application, the air exhaust opening 431 is located on a sidewall between the top portion and the bottom portion of the external enclosure 10. As the air outlet passage 43 is arranged to extend from the top portion of the external enclosure 10 toward the bottom portion, arranging the air exhaust opening 431 in a sidewall of the external enclosure 10 makes discharged air flowing in a curving way when passing through the air outlet passage 43, and this reduces the speed that air is discharged out through the air exhaust opening 431 and reduces the noise induced in operation and also avoid influence to the external environment caused by high speed airflows to thereby enhance experience of use. Certainly, in other embodiments, the air exhaust opening 431 can be arranged at other locations according to the construction of the external enclosure 10, such as being arranged in the top portion of the external enclosure 10.

As shown in FIG. 2, in an embodiment of the application, a cross-sectional area of the air outlet passage 41 perpendicular to a flowing direction of air is greater than a cross-sectional area of the air inlet passage 43 perpendicular to a flowing direction of air. It is noted that the narrower the passage, the greater the flowing speed of air and the greater the noise generated thereby. In the embodiment increasing the cross-sectional area of the air outlet passage 41 can reduce the flowing speed of air and can reduce noise to enhance the users' experience of use. Illustratively, widths of cross-sections of the air inlet passage 43 and the air outlet passage 41 perpendicular to the flowing directions of air are the same, and a width of the cross-section of the air outlet passage 41 perpendicular to the flowing direction of air is greater than a width of the cross-section of the air inlet passage 43 perpendicular to the flowing direction of air so as to realize the different cross-sectional areas as discussed above. More specifically, a spacing distance between an external sidewall of the interior chamber 10a and a shell wall opposite thereto is smaller than a spacing distance between an external wall of the external enclosure 10 and a shell wall opposite thereto.

As shown in FIG. 2, in an embodiment of the application, the air freshening unit 40 further comprises a filter assembly 45, and the filter assembly 45 is arranged in the air outlet passage 43. It is noted that kitchen waste carries odor and bacteria, and the blower 42 is operated to draw out air from the interior of the reaction chamber 20a, the air also carries odor and bacteria. By arranging the filter assembly in the air outlet passage 43, the odor and bacteria carried by the air can be absorbed so as to prevent the air carrying odor and bacteria from being discharged to the outside. As such, the user's experience of use can be enhanced. Certainly, in other embodiments, the filter assembly can also be alternatively arranged in the air inlet passage 41 to treat air discharged therethrough.

In some embodiments, the filter assembly comprises activated carbon. Activated carbon can adsorb odor and bacteria carried in air in order to ensure discharged air is clean and odorless. The filter assembly may further comprise a High-Efficiency Particulate Air (HEPA) filter core or an electrostatic filter core. The HEPA filter core and the electrostatic filter core may filter off small particulates entraining in air, such as bacteria, viruses, pollens, and dust mites to ensure discharged air is clean and odorless.

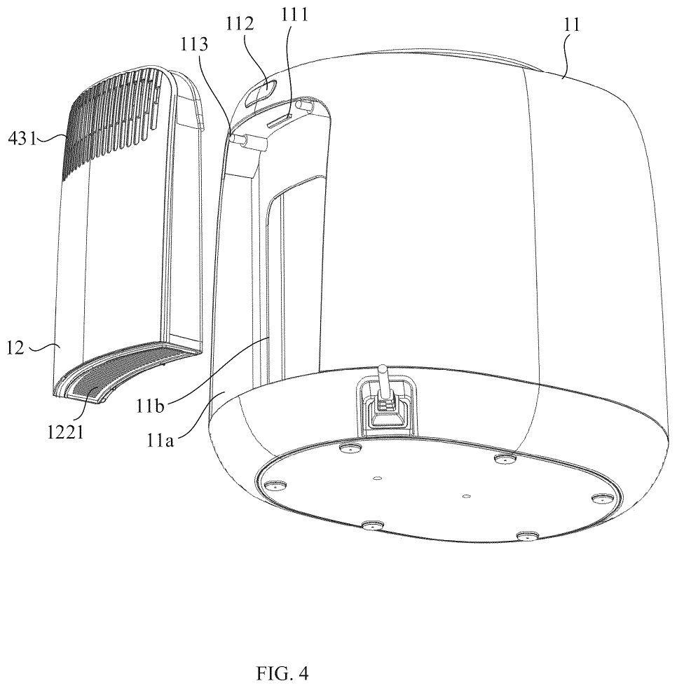

As shown in FIGS. 2 and 4, in an embodiment of the application, the external enclosure 10 comprises a first casing 11 and a second casing 12. The air exhaust opening 431 is formed in an external wall of the second casing 12 is formed. The first casing 11 is formed with an air exhaust compartment 11a having a sidewall having an opening. An air intake compartment 11b is formed in a compartment bottom of the air exhaust compartment 11a and faces the opening of the sidewall. The second casing 12 is removably connectable to the first casing 11, and an external wall of the second casing 12 covers and closes the opening of the air exhaust compartment 11a, while an internal wall of the second casing 12 covers and closes an opening of the air intake compartment 11b. The air exhaust compartment 11a and the external wall and the internal wall of the second casing 12 are structured to form at least a portion of the air outlet passage 43, and the internal wall of the second casing 12 and the air intake compartment 11b are structured to form at least a portion of the air inlet passage 41. The user may remove the second casing 12 from the first casing 11 as desired for timely cleaning the air inlet passage 41 and the air outlet passage 43 of the air freshening unit 40 in order to prevent pollution.

In some embodiments, a filter chamber 44 is arranged between the internal wall and the external wall of the second casing 12. The filter chamber 44 is formed with a first grating air passageway in a top portion thereof and a second grating air passageway 1221 in a bottom portion thereof. With the second casing 12 mounted in the first casing 11, the filter chamber 44 is structured to form a portion of the air outlet passage 43, and the filter chamber 44 serves to receive disposition of the filter assembly therein to filter air passing through the air outlet passage 43. It is noted that as the second casing 12 and the first casing 11 are removably connected, the user may remove the second casing 12 as desired in order to timely replace the filter assembly inside the filter chamber 44 to ensure effective filtering on discharged air.

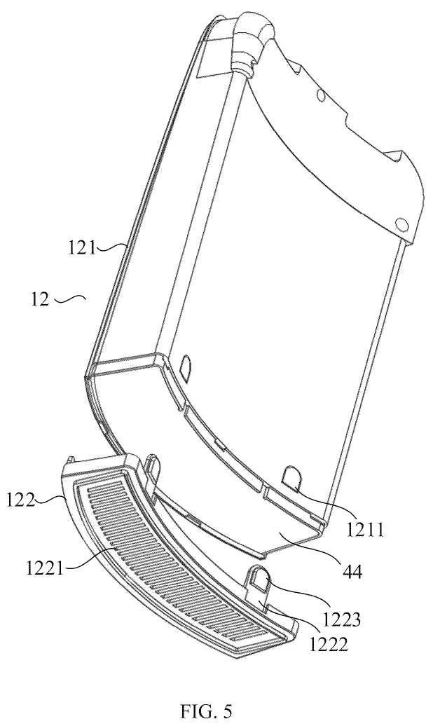

As shown in FIG. 5, in some embodiments, the second casing 12 comprises a top shell 121 and a bottom lid 122. The bottom lid 122 is removably mounted to a bottom portion of the top shell 121 to delimit and define, together with the top shell 121, the filter chamber 44. The second grating air passageway 1221 is arranged in the bottom lid 122. In the instant embodiment, the bottom lid 122 is mounted, through chute fitting, to the bottom portion of the top shell 121. Specifically, the bottom lid 122 is provided with engagement plates 1222 projecting toward the top shell 121. The engagement plates 1222 comprise engagement blocks 1223 protruding outward. The top shell 121 is formed with engagement holes 1211. The bottom lid 122 is mounted to the bottom portion of the top shell 121, such that the engagement plates 1222 are inserted into interior of the top shell 121, and the engagement blocks 1223 are fit into and engaged in the engagement holes 1211, so as to fulfill secured mounting of the top shell 121 and the bottom lid 122. Arranging the bottom lid 122 in a removable manner is advantageous in replacing the filter assembly to ensure effective filtering on the discharged air. In other embodiments, the bottom lid 122 is attachable to the bottom portion of the top shell 121 by means of bolts or snap fastening.

As shown in FIGS. 2A and 5, further, in the instant embodiment, the filter assembly 45 comprises activated carbon 452 and filter sponge 454 arranged at a bottom portion of the activated carbon 452. The filter sponge 454 is arranged above the bottom lid 122 to filter off impurities of relatively large particles. Air moves, in sequence, through the filter sponge 454 and the activated carbon 452 to discharge out, and the dual-layered filter enhances the effect of filtering. Further, the filter sponge 454 has an effect of reducing noise and also blocking carbon powder of the activated carbon falling toward the second grating air passageway 1221.

In some embodiments, a locking buckle 111 is arranged in a wall of a top portion of the air exhaust compartment 11a. A controller member 112 is provided in a sidewall of the first casing 11 to control movement of the locking buckle 111. Pressing down the controller member 112 controls the locking buckle 111 to be retracted into the wall of the top portion of the air exhaust compartment 11a. In a condition of not pressing down the controller member 112, the locking buckle 111 projects out of the wall of the top portion of the air exhaust compartment 11a. After the second casing 12 is mounted in the first casing 11, the locking buckle 111 securely fits into to be in retaining engagement with a locking opening in the top portion of the second casing 12 to ensure secured mounting of the second casing 12. After the controller member 112 is pressed down, the locking buckle 111 is disengaged from the locking opening and the second casing 12 is allowed to remove from the first casing 11.

In some embodiments, an elastic element 113 is arranged on a compartment bottom of the air exhaust compartment 11a to face toward the opening, and after the controller member 112 is pressed down, the elastic element 113 elastically ejects the second casing 12 out for quick removal of the second casing 12 to ease cleaning and replacement of the filter assembly by the user.

As shown in FIGS. 1-3, in an embodiment of the application, the first gap is present between a circumference of the cover 30 and the access opening 10b. After the blower 42 draws out air from the interior of the reaction chamber 20a, the external air passes around the circumference of the cover 30 to get into the interior of the reaction chamber 20a. As such, the external air is allowed to uniformly move into every part of the interior of the reaction chamber 20a to ensure sufficient processing reaction for kitchen waste inside the reaction chamber 20a.

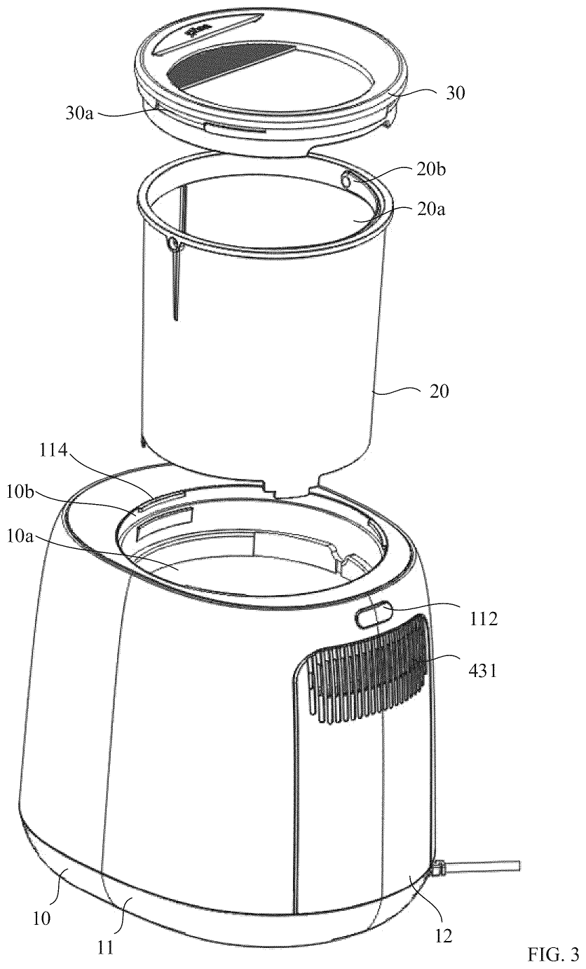

As shown in FIG. 3, in some embodiments, the cover 30 is removably arranged in the access opening 10b. Specifically speaking, the access opening 10b is provided, on a circumference thereof, with a plurality of fixing members 114, and the cover 30 is formed, in a circumference thereof, with a plurality of fixing notches 30a. The fixing notches 30a are each an L-shaped opening that is opened toward a down side. To mount the cover 30 in the access opening 10b, the fixing members 114 are disposed into the fixing notches 30a, and the cover 30 is rotated to have the fixing members 114 fit into and retained in the fixing notches 30a. To remove the cover 30, the cover 30 is rotated reversely to allow the fixing members 114 to disengage from the fixing notches 30a.

In some further embodiments, one end of the cover 30 is rotatably connected to the access opening 10b. Specifically speaking, one side of the access opening 10b is hinged to one side of the cover 30, and through rotation of the cover 30, the access opening 10b is closed or the access opening 10b is opened.

As shown in FIG. 2, in an embodiment of the application, the garbage disposal device 100 further comprises a stirring mechanism 50. The stirring mechanism 50 comprises a stirring blade support 51, a stirring axle 53, and a stirring electric motor 52. The stirring electric motor 52 is arranged in the interior of the external enclosure 10. The stirring electric motor 52 is connected to the stirring axle 53. A portion of the stirring axle 53 protrudes out of the bottom portion of the interior chamber 10a. The bottom portion of the internal barrel 20 is provided with a connection portion, and the stirring blade support 51 is located on the bottom portion of the reaction chamber 20a and is rotatably connected to the connection portion. The stirring axle 53 extends through the connection portion and is removably connected to the stirring blade support 51. The arrangement of the stirring mechanism 50 allows for stirring of kitchen waste inside the reaction chamber 20a to avoid piling up so as to allow air to get into the kitchen waste for further making the kitchen waste sufficiently reacted and increasing the reaction efficiency of the kitchen waste. It is noted that the stirring blade support 51 is arranged at the bottom portion of the reaction chamber 20a, and when the internal barrel 20 is removed out of the interior chamber 10a, the stirring blade support 51 is also separated from the stirring axle 53; and when the internal barrel 20 is placed into the interior chamber 10a, the stirring blade support 51 and the stirring axle 53 are connected so that with the stirring electric motor 52 driving the stirring axle 53 to rotate, the stirring blade support 51 is caused to rotate together with the stirring axle 53. As such, operation safety can be enhanced.

In some embodiments, the stirring blade support 51 comprises a plurality of stirring blades for stirring kitchen waste at every position. Illustratively, the stirring blade support 51 comprises two stirring blades, and the two stirring blades are arranged sequentially in an axial direction of the stirring axle 53, and an included angle is defined between the two stirring blades. One of the stirring blades is located on the bottom portion of the reaction chamber 20a, and as such, while stirring of a bottom portion of the kitchen waste is fulfilled, a top part of the kitchen waste is also stirred to thereby ensure sufficient stirring of the kitchen waste.

As shown in FIG. 2, in an embodiment of the application, the garbage disposal device 100 further comprises a weighing assembly 60. The weighing assembly 60 is arranged at the bottom portion of the interior chamber 10a to weigh the kitchen waste inside the internal barrel 20. When the internal barrel 20 is placed on the bottom portion of the interior chamber 10a, the weighing assembly 60 may weigh the kitchen waste inside the internal barrel 20 to identify the amount of the kitchen waste inside the reaction chamber 20a, and to control time and mode of the processing reaction of the garbage disposal device 100 according to the amount of the kitchen waste for more sufficiently performing the processing reaction on the kitchen waste.

In some embodiments, a bottom tray is arranged at the bottom portion of the interior chamber 10a, and the stirring electric motor 52 and the stirring axle 53 are fixed on the bottom tray. The bottom portion of the internal barrel 20 is formed with a positioning trough, and when the internal barrel 20 is placed on the bottom tray, the bottom tray matches and is located in the positioning trough, and the stirring axle 53 and the stirring blade support 51 are connected. When the bottom tray is placed on the weighing assembly 60, the weighing assembly 60 may identify a total weight of the bottom tray, the internal barrel 20, the kitchen waste in the reaction chamber 20a, and the stirring mechanism 50. A control terminal, on the basis of knowing in advance the weights of the bottom tray, the internal barrel 20, and the stirring mechanism 50, may acquire the weight of the kitchen waste disposed in the reaction chamber 20a. Illustratively, the weighing assembly 60 comprises a plurality of pressure transducers, and a pressure signal can be obtained through pressures applied from the bottom tray to the plurality of pressure transducer, and then, the pressure signal is fed back to the control terminal to obtain the total weight of the bottom tray, the internal barrel 20, the kitchen waste in the reaction chamber 20a, and the stirring mechanism 50.

In some other embodiments, the weighing assembly 60 comprises a weighing tray, and the bottom portion of the internal barrel 20 is formed with a positioning trough. When the internal barrel 20 is placed on the weighing tray, the weighing tray matches and is located in the positioning trough, and the stirring axle 53 extends through the weighing tray to connect with the stirring blade support 51. The weighing tray feeds the pressure signal back to the control terminal, and the control terminal, on the basis of knowing in advance the weight of the internal barrel 20, may obtain the weight of the kitchen waste disposed in the reaction chamber 20a.

As shown in FIG. 2, in an embodiment of the application, the garbage disposal device 100 further comprises a heating assembly 70. The heating assembly 70 comprises a heat source and a heating filament. The heat source is arranged in the external enclosure 10, and the heating filament is arranged in the bottom portion of the internal barrel 20, or alternatively, the heating filament is arranged in the bottom portion of the interior chamber 10a. The heating filament is electrically connected with the heat source for heating the internal barrel 20. Heating is induced on the heating filament with the heat source, so as to heat the internal barrel 20 to set a proper temperature for the internal barrel 20 to accelerate the activity of the microorganisms, thereby further having the kitchen waste sufficiently reacted and to increase the reaction efficiency of the kitchen waste. It is noted that in removing the internal barrel 20 from the interior chamber 10a, either the connection between the heating filament and the heat source is broken, or the heating filament and the internal barrel 20 are detached from each other in order to enhance safety of operation.

In some embodiments, the heating filament is arranged, in a serpentine form, in the bottom portion of the internal barrel 20. A first electrical connection portion is arranged at an end portion of the heating filament. The heat source is arranged in the external enclosure 10. A second electrical connection portion is arranged on the heat source. When the internal barrel 20 is placed into the interior chamber 10a, the first electrical connection portion is set in contact engagement with the second electrical connection portion in order to heat the heating filament of the heat source and to heat the internal barrel 20.

In some further embodiments, the heating filament is arranged in the bottom portion of the interior chamber 10a, and when the internal barrel 20 is placed in the interior chamber 10a, the heating filament is set in contact with the bottom portion of the internal barrel 20 in order to have the internal barrel 20 heated by the heating filament. Illustratively, the heating filament is arranged, in a serpentine form, on the bottom tray, and the internal barrel 20, when placed on the bottom tray, is set in contact engagement with the heating filament.

In some embodiments, a humidity detection sensor is further included. The humidity detection sensor is partly arranged in the reaction chamber 20a to detect humidity of the interior of the reaction chamber 20a in order to control the humidity of the interior of the reaction chamber 20a to be set at a proper reaction condition for reaction of the kitchen waste.

In some embodiments, a temperature detection sensor is further included. The temperature detection sensor is arranged in the interior chamber 10a and is in contact engagement with a barrel wall of the internal barrel 20. The temperature detection sensor detects a temperature in order to control the temperature of the interior of the reaction chamber 20a to be set at a proper reaction condition for reaction of the kitchen waste.

An embodiment of the application also provides a control method of the garbage disposal device 100, which comprises:

After kitchen waste is placed into the reaction chamber 20a, the control terminal controls the blower 42 to operate intermittently to successively draw air that has been subjected to reaction from the interior of the reaction chamber 20a, and to allow external air to pass through the first gap to flow into the reaction chamber 20a for full reaction of the kitchen waste. The blower 42 is intermittently operated, meaning the blower 42 is put into operation at intervals, and during the non-operating intervals of the blower 42, supplied fresh air allows the kitchen waste inside the reaction chamber 20a to react, and during the operating intervals of the blower 42, the air that has been subjected to reaction is drawn out of the reaction chamber 20a to allow the external fresh air to get into the reaction chamber 20a, this being so cyclically repeated.

In the instant embodiment, controlling the blower 42 to operate intermittently allows processing reaction to be carried out on the kitchen waste inside the reaction chamber 20a through continuous supply of fresh air. Compared to operating in a continuous manner, on the one hand, electrical power can be saved, and on the other hand, reaction of the kitchen waste is prevented from being affected by uninterrupted airflows.

In some embodiments, the control method of the garbage disposal device 100 further comprises:

The control terminal acquires the weight of the kitchen waste inside the reaction chamber 20a according to a weight obtained by the weighing assembly 60, and the control terminal controls the time of processing reaction of the garbage disposal device 100 according to the weight of the kitchen waste inside the reaction chamber 20a. For example, the heavier the weight of the kitchen waste, the longer the time of processing reaction of the garbage disposal device 100. As such, sufficient reaction of the kitchen waste inside the reaction chamber 20a can be ensured.

In some embodiments, the control method of the garbage disposal device 100 further comprises: a continuous fermentation scheme, a quick fermentation scheme, a low-temperature fermentation scheme, and a grassland fermentation scheme.

To operate in the continuous fermentation scheme, the stirring electric motor 52 rotates forward for 20 s, shut down for 40 s, and rotating reversely for 20 s, and the heating assembly 70 and the air freshening unit 40 operate synchronously. When the temperature of the interior of the reaction chamber 20a reaches 63° C., the heating assembly 70 stops operation, while the stirring electric motor 52 continuously operates, until the temperature of the interior of the reaction chamber 20a drops down to 57° C., and then, the heating assembly 70 is activated again to heat up to 63° C., and this is cyclically implemented for 4 h, and then the humidity detection sensor detects the humidity of the kitchen waste, and the cyclic operation continues before the humidity reaches 45%, and once the humidity reaches 45%, entry is made into a cooling mode. In the cooling mode, the stirring electric motor 52 rotates forward for 30 s, shut down for 90 s, and rotating reversely for 30 s, and the blower 42 operates synchronously, until the temperature becomes lower than 35° C., and then the garbage disposal device 100 enters standby. In the standby condition of the garbage disposal device 100, at every interval of 2 h, the stirring electric motor 52 rotates forward for 30 s, and rotates reversely for 30 s, while the blower 42 operates for 1 min, and the heating assembly 70 operates for heating until the temperature of the interior of the reaction chamber 20a reaches 63° C. to get stopped.

To operate in the quick fermentation scheme, the stirring electric motor 52 rotates forward for 30 s, shut down for 40 s, and rotating reversely for 30 s, and the heating assembly 70 and the air freshening unit 40 operate synchronously. The air freshening unit 40 and the heating assembly 70 control the temperature of the interior of the reaction chamber 20a to be 110° C.-125° C. After operation for 1 h, the humidity detection sensor detects the humidity of the kitchen waste, and the air freshening unit 40 and the heating assembly 70 control the humidity of the interior of the reaction chamber 20a to have the humidity reach 35% to enter the fermentation mode. In the fermentation mode, the stirring electric motor 52 rotates forward for 30 s, shut down for 90 s, and rotating reversely for 30 s, and the blower 42 operates synchronously, until the temperature becomes lower than 35° C., and then the garbage disposal device 100 enters standby.

To operate in the low-temperature fermentation scheme, enzymes are also added into the reaction chamber 20a, and the stirring electric motor 52 rotates forward for 20 s, shut down for 40 s, and rotating reversely for 20 s, and the heating assembly 70 and the air freshening unit 40 operate synchronously. When the temperature of the interior of the reaction chamber 20a reaches 63° C., the heating assembly 70 stops operation, while the stirring electric motor 52 continuously operates, until the temperature of the interior of the reaction chamber 20a drops down to 57° C., and then, the heating assembly 70 is activated again to heat up to 63° C., and this is cyclically implemented for 2 h, and then the humidity detection sensor detects the humidity of the kitchen waste, and the cyclic operation continues before the humidity reaches 45%, and once the humidity reaches 45%, entry is made into a cooling mode. In the cooling mode, the stirring electric motor 52 rotates forward for 30 s, shut down for 90 s, and rotating reversely for 30 s, and the blower 42 operates synchronously, until the temperature becomes lower than 35° C., and then the garbage disposal device 100 enters standby.

To operate in the grassland fermentation scheme, enzymes are also added into the reaction chamber 20a, and the stirring electric motor 52 rotates forward for 30 s, shut down for 40 s, and rotating reversely for 30 s, and the heating assembly 70 and the air freshening unit 40 operate synchronously. When the temperature of the interior of the reaction chamber 20a reaches 63° C., the heating assembly 70 stops operation, while the stirring electric motor 52 continuously operates, until the temperature of the interior of the reaction chamber 20a drops down to 57° C., and then, the heating assembly 70 is activated again to heat up to 63° C., and this is cyclically implemented for 2 h, and then the humidity detection sensor detects the humidity of the kitchen waste, and the cyclic operation continues before the humidity reaches 35%, and once the humidity reaches 35%, entry is made into a cooling mode. In the cooling mode, the stirring electric motor 52 rotates forward for 30 s, shut down for 90 s, and rotating reversely for 30 s, and the blower 42 operates synchronously, until the temperature becomes lower than 35° C., and then the garbage disposal device 100 enters standby.

In each of the above schemes, the blower 42 is operated in an intermittent manner to allow processing reaction to be carried out on the kitchen waste inside the reaction chamber 20a through continuous supply of fresh air.

In some embodiments, the control method of the garbage disposal device 100 further comprises: a first cleaning scheme and a second cleaning scheme.

After the kitchen waste is dumped out, water is introduced into the reaction chamber 20a to cover the stirring blade support 51, and the first cleaning scheme is operated. To operate the first cleaning scheme, the stirring electric motor 52 rotates forward for 30 s, shut down for 40 s, and rotating reversely for 30 s, and operates for 30 min, and the heating assembly 70 operates synchronously and heats up the temperature of the interior of the reaction chamber 20a to 80° C.±5° C. After completion of soaking, dirt water is poured out of the reaction chamber 20a and clean water is supplied to wash and clean the reaction chamber 20a. This cleans the reaction chamber 20a to prevent bacteria breeding and remaining of odor to ease up the next round of fermentation of kitchen waste. In the embodiment, the blower 42 is not in operation and water is applied to clean the reaction chamber 20a.

After the kitchen waste is dumped out, it is also possible to operate the second cleaning scheme. In the operation of the second scheme, the heating assembly 70 heats up the temperature of the interior of the reaction chamber 20a to 120° C.±5° C., and the blower 42 is synchronously activated and operates for 30 min and then shuts down. In the embodiment, the blower 42 operates in a continuous manner in order to draw the after-reaction air out of the interior chamber 10a or the reaction chamber 20a, and the filter assembly is applied to clean and remove odor from the air, in order to prevent bacteria breeding and remaining of odor to improve user's experience of use.

In some embodiments, the control terminal of the garbage disposal device 100 is operable to monitor operation parameters of the garbage disposal device 100. The control terminal may establish a communication relationship with respect to other electronic devices, such as a user's mobile phone. The operation parameters of the garbage disposal device 100 can then be displayed by means of software of the electronic devices. In other embodiments, the garbage disposal device 100 may comprise a display screen, and the operation parameters are displayed by means of the display screen.

In the instant embodiment, the operation parameters include at least one of the fermentation scheme type, the temperature of the internal barrel 20, the operation condition of the blower 42, the operation condition of the stirring electric motor 52, the operation condition of the heating assembly 70, elapsed operation time of the current fermentation scheme, remaining operation time of the current scheme, count of operations of the filter assembly, the weight of the kitchen waste inside the internal barrel 20, the total weight of garbage processed in the current round of composting process, the total emission of carbon neutralized by the weight of fertilizer generated in the current round of compositing. In this, the total carbon emission is obtained by multiplying the total weight of garbage processed in the current round of composting process with a ratio. Through timely pushing implemented with the electronic devices for the operation parameters of the garbage disposal device 100, the user may intuitively realize the operation condition of the composting system, and can timely find out malfunctioning of the garbage disposal device 100 or completion of composting operation, to thereby facilitate enhancement of the user's experience.

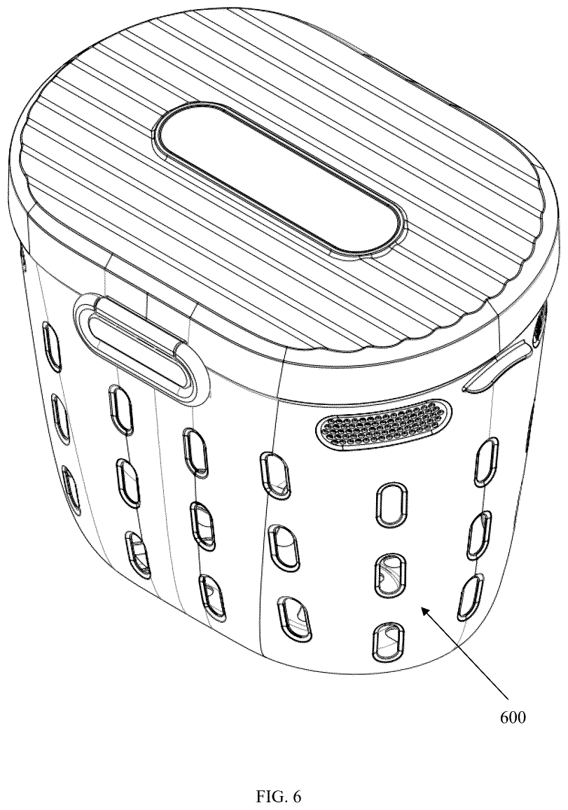

An embodiment of the application also provides a composting system, which comprises a vermicompost bucket 600 as shown in FIG. 6 and the garbage disposal device 100.

The vermicompost bucket 600 functions to receive the reaction-completed kitchen waste from the garbage disposal device 100 for further conversion of the reaction-completed kitchen waste. After the garbage disposal device 100 completes the reaction of the kitchen waste, the kitchen waste inside the reaction chamber 20a is removed out, and the reaction-completed kitchen waste is poured into the vermicompost bucket 600. Specifically, the internal barrel 20 is removed out of the interior chamber 10a, and the reaction-completed kitchen waste contained in the reaction chamber 20a is directly poured into the vermicompost bucket 600. The vermicompost bucket 600 uses the biotransformation capability of earthworms to digest and decompose the reaction-completed kitchen waste for further conversion into an organic fertilizer absorbable by green plants.

The above describes only the preferred embodiments of the application and is not intended to limit the scope of the claims. Equivalent conversions of structure that are made under the application idea of the application by using the contents of the disclosure and the attached drawings of the application, or direct/indirect application thereof to other fields of technology, are included in the scope of patent protection that the application pursues.

What is claimed is:

1. A garbage disposal device, comprising:
an external enclosure, the external enclosure being formed with an interior chamber and an access opening in communication with the interior chamber;
an internal barrel, the internal barrel being formed with a reaction chamber and an introduction opening in communication with the reaction chamber, the reaction chamber being configured to accommodate kitchen waste therein, the internal barrel being disposed in the interior chamber, the introduction opening facing the access opening;
a cover, the cover being arranged in the access opening, a first gap being present between the cover and the access opening; and
an air freshening unit, the air freshening unit comprising a blower, an air inlet passage, and an air outlet passage, an air ingress portion of the blower being in communication with the air inlet passage, an air egress portion of the blower being in communication with the air outlet passage, the air inlet passage being in communication with the reaction chamber;
wherein the blower is operable to draw air from the reaction chamber through the air inlet passage to allow external air to flow through the first gap into the reaction chamber for reaction of the kitchen waste inside the reaction chamber.

2. The garbage disposal device according to claim 1, wherein the external enclosure comprises an enclosure wall which is configured to form the air inlet passage and the air outlet passage, and the blower is arranged in the external enclosure.

3. The garbage disposal device according to claim 2, wherein a mounting compartment is arranged in a bottom portion of the external enclosure, and the blower is mounted in the mounting compartment, the air inlet passage being located in an external sidewall of the interior chamber, the air outlet passage being adjacent to the air inlet passage, the air inlet passage and the air outlet passage being both extending from a top portion of the external enclosure to the bottom portion, an air intake opening being formed in a top portion of the air inlet passage, the air intake opening being in communication with the reaction chamber, a bottom portion of the air inlet passage being in communication with a top portion of the mounting compartment, a bottom portion of the air outlet passage being in communication with a sideway portion of the mounting compartment, an air exhaust opening being arranged in a top portion of the air outlet passage, the air exhaust opening being arranged at an external wall of the external enclosure.

4. The garbage disposal device according to claim 3, wherein the air exhaust opening is located in a sidewall between the top portion and the bottom portion of the external enclosure.

5. The garbage disposal device according to claim 4, wherein the external enclosure comprises a first casing and a second casing, the air exhaust opening being arranged in an external wall of the second casing, the first casing being formed with an air exhaust compartment having a sidewall having an opening, an air intake compartment being formed in a compartment bottom of the air exhaust compartment and facing the opening of the sidewall, the second casing being detachably connected to the first casing, the external wall of the second casing covering and closing the opening of the air exhaust compartment, an internal wall of the second casing covering and closing an opening of the air intake compartment, the air exhaust compartment and the external wall and the internal wall of the second casing cooperatively forming at least a portion of the air outlet passage, the internal wall of the second casing and the air intake compartment cooperatively forming at least a portion of the air inlet passage.

6. The garbage disposal device according to claim 5, wherein the second casing further comprises an internal wall spaced from the external wall, and a filter chamber formed between the internal wall and the external wall; and
the filter chamber comprises a first grating air passageway formed in a top portion thereof and a second grating air passageway formed in a bottom portion thereof; and
the filter chamber forms a portion of the air outlet passage.

7. The garbage disposal device according to claim 6, wherein the second casing comprises a top shell and a bottom lid removably mounted to a bottom portion of the top shell to delimit and define, together with the top shell the filter chamber;
the second grating air passageway is arranged in the bottom lid; and
the internal wall and the external wall are formed by the top shell.

8. The garbage disposal device according to claim 6, wherein the air freshening unit further comprises a filter assembly arranged in the filter chamber;
the filter assembly comprises activated carbon and a filter sponge arranged at a bottom portion of the activated carbon;
the filter sponge is arranged above the bottom lid to filter off impurities of relatively large particles.

9. The garbage disposal device according to claim 5, wherein a locking buckle is arranged in a wall of a top portion of the air exhaust compartment; a controller member is provided in a sidewall of the first casing to control movement of the locking buckle.

10. The garbage disposal device according to claim 9, wherein an elastic element is arranged on a compartment bottom of the air exhaust compartment to face toward the opening; and
after the controller member is pressed down, the elastic element is capable of elastically ejecting the second casing out for quick removal of the second casing.

11. The garbage disposal device according to claim 1, wherein a cross-sectional area of the air outlet passage perpendicular to a flowing direction is greater than a cross-sectional area of the air inlet passage perpendicular to the flowing direction.

12. The garbage disposal device according to claim 1, wherein the air freshening unit further comprises a filter assembly arranged in the air outlet passage.

13. The garbage disposal device according to claim 1, wherein the first gap is located between a circumference of the cover and the access opening.

14. The garbage disposal device according to claim 1, further comprising a stirring mechanism, wherein the stirring mechanism comprises a stirring blade support, a stirring axle, and a stirring electric motor, the stirring electric motor being arranged in the external enclosure, the stirring electric motor being connected to the stirring axle, the stirring axle partly projecting out of a bottom portion of the interior chamber; the bottom portion of the internal barrel being provided with a connection portion, the stirring blade support being located in a bottom portion of the reaction chamber and rotatably connected to the connection portion, the stirring axle extending through the connection portion and detachably connected to the stirring blade support.

15. The garbage disposal device according to claim 1, further comprising a weighing assembly, wherein the weighing assembly is arranged in a bottom portion of the interior chamber to weigh the kitchen waste accommodated in the internal barrel.

16. The garbage disposal device according to claim 1, further comprising a heating assembly, wherein the heating assembly comprises a heat source and a heating filament being electrically connected with the heat source for heating the internal barrel; the heat source being arranged in the external enclosure; the heating filament being arranged in a bottom portion of the internal barrel or a bottom portion of the interior chamber.

17. A control method applicable to the garbage disposal device according to claim 1, comprising:
after the kitchen waste being placed in the reaction chamber, controlling the blower to operate in an intermittent manner to successively draw after-reaction air out from the reaction chamber to allow external air to flow through the first gap into the reaction chamber for full reaction of the kitchen waste.

18. A composting system, comprising a vermicompost bucket and the garbage disposal device according to claim 1,
wherein the vermicompost bucket is configured to receive reaction-completed kitchen waste from the garbage disposal device to further process the reaction-completed kitchen waste.
